(19) United States
(12) Patent Application Publication
(10) Pub. No.: US 2021/0229524 A1
(43) Pub. Date: Jul. 29, 2021

(54) VEHICLE HEATER

(71) Applicant: Eberspächer Climate Control Systems GmbH, Esslingen (DE)

(72) Inventor: Andreas COLLMER, Aichwald (DE)

(21) Appl. No.: 17/159,877

(22) Filed: Jan. 27, 2021

(30) Foreign Application Priority Data
Jan. 28, 2020 (DE) 10 2020 101 963.7

(51) Int. Cl. B60H 1/22

(52) U.S. Cl. CPC B60H 1/2212

(57) ABSTRACT

A vehicle heater includes a housing (10) with a circumferential wall (12), defining a combustion air flow space (14), having a fuel line passage opening (30), a combustion chamber assembly unit, and a fuel line (28). The fuel line has a connection end area (54) adjoining the combustion chamber assembly unit (18), an external connection end area (58), outside the circumferential wall and a line area (56) between the end areas and passing through the fuel line passage opening. A sealing formation (32) has a first sealing area (34), meshing with the fuel line passage opening, and a passage opening (52) through which the line area of the fuel line passes. The fuel line has a larger cross-sectional dimension in a throughput length area (60), passing through the passage opening, than in a section of the line area located between the throughput length area and the external connection area.

### CROSS REFERENCE TO RELATED APPLICATIONS

This application claims the benefit of priority under 35 U.S.C. § 119 of German Application 10 2020 101 963.7, filed Jan. 28, 2020, the entire contents of which are incorporated herein by reference.

### TECHNICAL FIELD

The present invention pertains to a vehicle heater, comprising a housing with a circumferential wall defining a combustion air flow space, a combustion chamber assembly unit to be fed with fuel and combustion air, a fuel feed line adjoining the combustion chamber assembly unit for feeding fuel to the combustion chamber assembly unit, wherein a fuel feed line passage opening is provided in the circumferential wall, wherein the fuel feed line comprises a combustion chamber assembly unit connection end area adjoining the combustion chamber assembly unit, an external connection end area located outside the circumferential wall and a line area extending between the combustion chamber assembly unit connection end area and the external connection end area and passing through the fuel feed line passage opening, as well as a sealing formation with a first sealing formation area, wherein the first sealing formation area is positioned such that it meshes with the fuel feed line passage opening for producing an essentially fluid-tight closure between the circumferential wall and the line area of the fuel feed line, wherein the sealing formation has in the first sealing formation area a passage opening through which the line area of the fuel feed line passes.

### TECHNICAL BACKGROUND

Such a vehicle heater is known from DE 10 2017 125 783 A1. The fuel feed line, which is generally provided as a metal pipe, passes through the sealing formation in the area of the passage opening provided in the first sealing formation area. The sealing formation, which is made of elastic material, adjoins, under prestress, the outer surface of the fuel feed line in its throughput length area passing through the passage opening and thus provides a tight connection to the fuel feed line.

### SUMMARY

An object of the present invention is to perfect a vehicle heater of this type such that an improved tightness is achieved in the area of the first sealing formation area.

This object is accomplished according to the present invention by a vehicle heater, comprising:
a housing with a circumferential wall defining a combustion air flow space,
a combustion chamber assembly unit to be fed with fuel and combustion air,
a fuel feed line adjoining the combustion chamber assembly unit for feeding fuel to the combustion chamber assembly unit, wherein a fuel feed line passage opening is provided in the circumferential wall, wherein the fuel feed line comprises a combustion chamber assembly unit connection end area adjoining the combustion chamber assembly unit, an external connection end area located outside the circumferential wall and a line area extending between the combustion chamber assembly unit connection end area and the external connection end area and passing through the fuel feed line passage opening, and
a sealing formation with a first sealing formation area, wherein the first sealing formation area is positioned such that it meshes with the fuel feed line passage opening for producing an essentially fluid-tight closure between the circumferential wall and the line area of the fuel feed line, wherein the sealing formation has in the first sealing formation area a passage opening through which the line area of the fuel feed line passes.

This vehicle heater is characterized in that the fuel feed line has a larger cross-sectional dimension in a throughput length area passing through the passage opening in the first sealing formation area than in a section of the line area, which section is located between the throughput length area and the external connection area.

In order to be able to connect the fuel feed line in its external connection end area located outside of the circumferential wall to a fuel line, which has a, for example, flexible configuration, the fuel feed line is generally provided in its external connection end area with a larger cross-sectional dimension than in its line area which connects the external connection end area to the combustion chamber assembly unit connection end area and is generally configured as a metal pipe.

During the assembly of a vehicle heater, the fuel feed line with its external connection end area with larger cross-sectional dimension is therefore passed through the passage opening in the first sealing formation area until the line area, with its throughput length area to be positioned such that it passes through the passage opening, comes to lie in the passage opening. Since, in case of the vehicle heater configured according to the present invention, the throughput length area is provided with a larger cross-sectional dimension in relation to the line area of the fuel feed line, which extends between the external connection end area and the combustion chamber assembly unit connection end area, the sealing formation can be provided in its first sealing formation area with a passage opening that has a basic opening cross-sectional dimension that is larger than the cross-sectional dimension of the fuel feed line in the line area outside the throughput length area. This avoids an excessive expansion of the first sealing formation area when the fuel feed line with its external connection end area is passed through the passage opening. The avoidance of an excessive expansion of the first sealing formation area ensures that the sealing formation with its first sealing formation area is in contact with the outer surface of the fuel feed line in the area of the throughput length area under sufficiently strong prestress when the fuel feed line is positioned with the throughput length area in the passage opening and thus produces a reliable tight closure.

It should be pointed out that in the sense of the present invention the basic opening cross-sectional dimension of the passage opening is the cross-sectional dimension, which the passage opening has before the fuel feed line is passed through the passage opening. The first sealing formation area is expanded in the process.

For example, an excessive expansion (or stretching) of the sealing formation during the insertion of the fuel feed line can be avoided by the basic cross-sectional dimension of the sealing formation passage opening, before introducing the fuel feed line such that the throughput length area is positioned passing through the sealing formation passage opening, being substantially the same, the same, or essentially the same as a cross-sectional dimension of the fuel feed line in the area of the external connection end area.

Such a dimensioning, in which the basic opening cross-sectional dimension is at least 90%, and preferably at least 100%, of the cross-sectional dimension of the fuel feed line in the area of the external connection end area, has been shown to be especially advantageous.

Furthermore, an excessive expansion of the sealing formation area can be avoided when a cross-sectional dimension of the fuel feed line in the throughput length area is substantially the same, the same, or essentially the same, as a cross-sectional dimension of the fuel feed line in the area of the external connection end area.

Here as well, provisions may be made, for example, for the cross-sectional dimension of the fuel feed line in the throughput length area to be at least 90%, and preferably at least 100%, of the cross-sectional dimension of the fuel feed line in the area of the external connection end area.

In order to ensure that the sealing formation is in contact with the fuel feed line under prestress in the assembled state, it is proposed that the basic opening cross-sectional dimension of the passage opening be smaller than a cross-sectional dimension of the fuel feed line in the throughput length area before the insertion of the fuel feed line such that the throughput length area is positioned such that it passes through the passage opening. For example, provisions may be made for the cross-sectional dimension of the fuel feed line in the throughput length area to be at least 105%, and preferably at least 110%, of the basic opening cross-sectional dimension.

In order to be able to provide the fuel feed line with expanded cross section in its throughput length area, the line area of the fuel feed line may be enclosed by a cross-sectional expansion device in the throughput length area.

In order to thereby produce a permanent and tight connection, it is proposed that the cross-sectional expansion device be fixed by connection in substance or/and by frictional engagement at the line area, or that the cross-sectional expansion device be formed in one piece with the line area.

The vehicle heater according to the present invention may be further configured such that a combustion air blower adjoining an end face of the circumferential wall of the housing in the direction of a housing longitudinal axis is provided for feeding combustion air into the combustion air flow space, and that the sealing formation has a second sealing formation area, wherein the second sealing formation area is arranged between the end face of the circumferential wall and the blower housing for producing an essentially fluid-tight closure between the end face of the circumferential wall and a blower housing of the combustion air blower.

For a simplified configuration guaranteeing a good tightness, the sealing formation may comprise a sealing element providing the first sealing formation area and the second sealing formation area.

The second sealing formation area has a ring-shape configuration, which is preferably adapted to a circumferential contour of the circumferential wall.

For the integration into the circumferential wall, it is proposed that the first sealing formation area extend from the second sealing formation area such that is projects essentially in the direction of the housing longitudinal axis and such that it meshes with the fuel feed line passage opening.

The sealing formation is preferably made of elastomer material, especially fuel-resistant elastomer material.

In the vehicle heater according to the present invention, the housing may be part of a heat exchanger housing, and the combustion chamber assembly unit may be carried at a bottom area of the heat exchanger housing.

The present invention will be described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of a part of a fuel-operated vehicle heater;

FIG. 2 is an axial view of the part of a vehicle heater shown in FIG. 1;

FIG. 3 is a partial longitudinal sectional view of the vehicle heater;

FIG. 4 is a perspective view of a sealing formation in conjunction with a fuel feed line;

FIG. 5 is a partial view of the sealing formation from FIG. 4 in viewing direction V in FIG. 4; and

FIG. 6 is an enlarged partial longitudinal sectional view of the part of a vehicle heater shown in FIG. 1.

### DESCRIPTION OF PREFERRED EMBODIMENTS

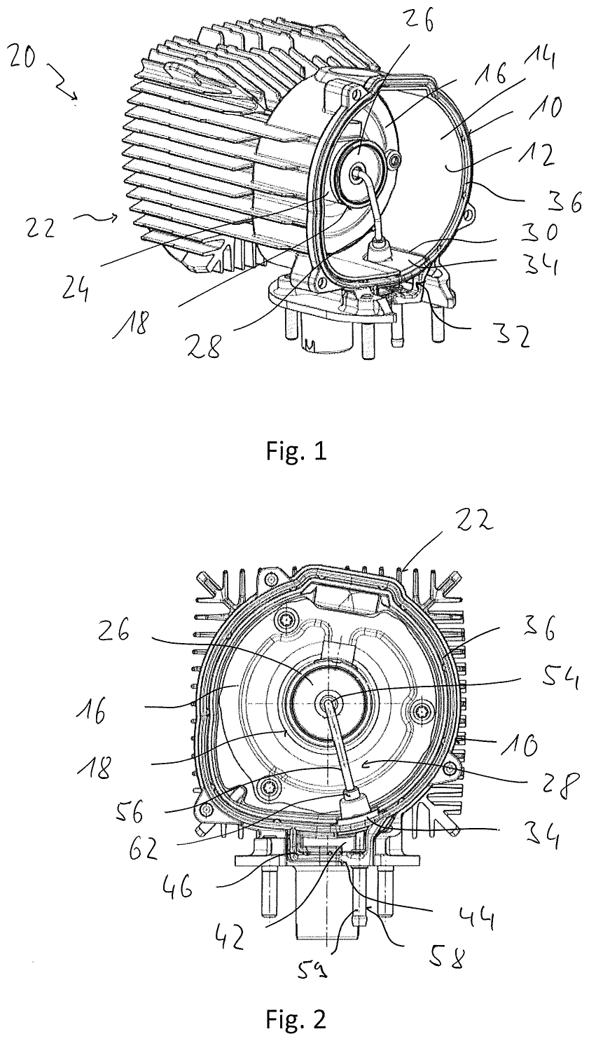

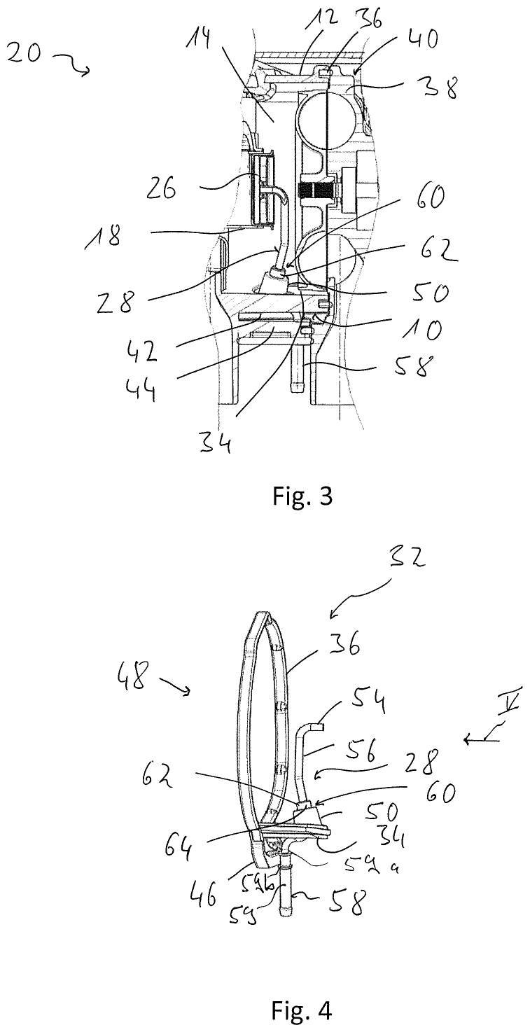

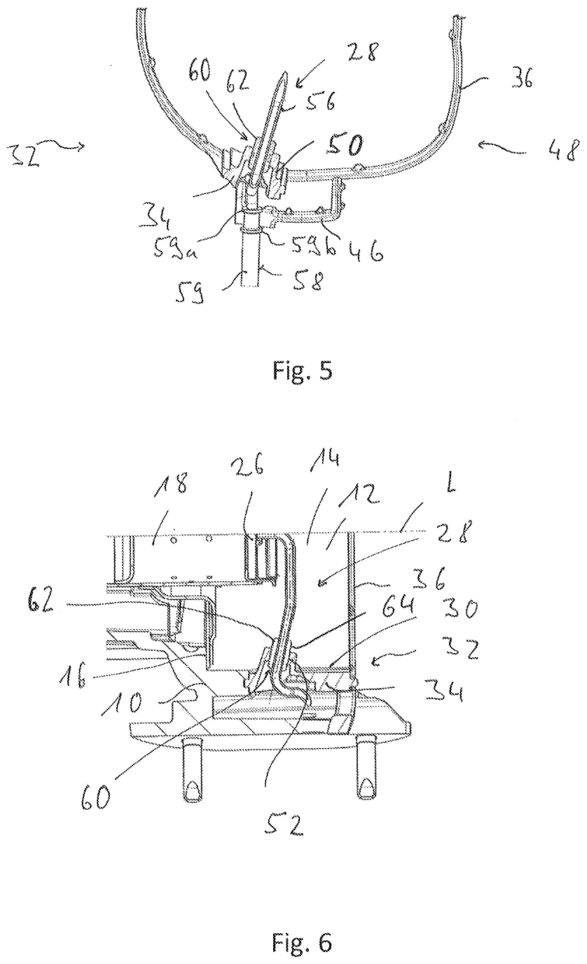

Referring to the drawings, FIG. 1 shows a housing of a vehicle heater, which housing is generally designated by 10, with a circumferential wall 12 that defines a combustion air flow space 14. A bottom area 16, which defines the combustion air flow space 14 in the direction of a housing longitudinal axis L and at which is carried a combustion chamber assembly unit of a vehicle heater 20, which combustion chamber assembly unit is generally designated by 18, adjoins the circumferential wall 12.

In the exemplary embodiment being shown, the housing 10 forms an integral component of a heat exchanger housing 22 of the vehicle heater 20, which heat exchanger housing is provided as a metal component. The combustion chamber assembly unit 18, which has a conventional configuration, is provided at this heat exchanger housing 22 or housing 10. The combustion chamber assembly unit 18 has, for this purpose, a combustion chamber housing with a circumferential wall 24 and with a bottom wall 26. A fuel feed line 28, which will be explained in more detail below, opens into the bottom wall 26, in order to introduce, in addition to the combustion air fed via the combustion air flow space 14, also the fuel necessary for combustion into a combustion chamber of the combustion chamber assembly unit 18, which combustion chamber is enclosed by the circumferential wall 24 and the bottom wall 26.

A fuel feed line passage opening 30, which is open axially in the direction away from the bottom area 16, is formed in the circumferential wall 12 of the housing 10. The fuel feed line 28 is passed through the fuel feed line passage opening 30 into the combustion air flow space 14. By means of a sealing formation, generally designated by 32, or by means of a first sealing formation area 34 of same, the fuel feed line passage opening 30 in the circumferential wall 12 of the housing 10 is closed tightly against the discharge of gas. The sealing formation 32 further comprises a second sealing formation area 36, which has a ring-shaped configuration and is adapted to the ring shape of the circumferential wall 12. This second sealing formation area is positioned between an end face of the circumferential wall 12 and a blower housing 38 of a combustion air blower, for example, a side channel blower, which is generally designated by 40, which blower housing is located opposite this end face. A tight closure against the discharge of gas is thus also achieved in the connection of the housing 10 to the combustion air blower 40.

A buffer chamber, generally designated by 42, is provided on the outer side of the circumferential wall 12 in the circumferential area of the circumferential wall 12 of the housing 10, in which the fuel feed line passage opening 30 is formed in the circumferential wall 12. This buffer chamber is enclosed by another circumferential wall 44, which is, for example, made integral with the circumferential wall 12 and likewise has an axially open opening, through which the fuel feed line 28 is passed. The sealing formation has in its second sealing formation area 36 a section 46 which produces a tight closure at an end face of the other circumferential wall 44 in contact with the other circumferential wall 44 or in connection of the other circumferential wall 44 to the blower housing 38.

The sealing formation 32 with its second sealing formation area 36, with the section 46 of said second sealing formation area and with the first sealing formation area 34 extending such that it projects in the direction of the housing longitudinal axis L is configured as an integral sealing element 48 made of elastomer material, especially fire-resistant elastomer material. An attachment 40, which extends into the combustion air flow space 14 and which provides a passage opening 52 for the fuel feed line 28, is provided at the first sealing formation area 34 for passing the fuel feed line 28 through the first sealing formation area 34 of the sealing formation 32 or of the sealing element 48.

The fuel feed line 28 has a combustion chamber assembly unit connection end area 54, which is connected tightly, for example, by welding or soldering, to the combustion chamber assembly unit 18, especially to the bottom wall 26 of same. This combustion chamber assembly unit connection end area 54 may be an end area of a line area 56 of the fuel feed line 28, which line area 56 also extends through the passage opening 52 and is generally provided as a metal pipe. The fuel feed line 28 further has an external connection end area 58 for connection to a, for example, flexible fuel line, which extends outside the housing 10 or the circumferential wall 12 and which leads to a fuel tank. This external connection end area 58 may be provided by a tubular or sleeve-shape connection piece 59, which is fixed to the pipe, especially metal pipe, providing the line area 56 and generally has a larger cross-sectional dimension, i.e., external dimension, than the line area 56 or metal pipe providing the line area 56. Provisions are especially generally made for the external connection end area 58 of the fuel feed line 28 to provide the length area of the fuel feed line 28, in which this [fuel feed line] has the largest cross-sectional dimension. Two, for example, ring-shape beads or flange areas 59a, 59b, which protrude in the radial outward direction at spaced locations from one another, are provided at the connection piece providing the external connection end area 58. For example, these [beads or flange areas] in interaction with the section 46 of the second sealing formation area 36 accommodated between them provide a tension/pressure relief for the fuel feed line 28. In the exemplary embodiment shown, these beads or flange areas 59a, 59b form the area of maximum cross-sectional dimension, i.e., for example, maximum external diameter in the case of a circular configuration, of the external connection end area 58.

In a throughput length area 60 positioned such that is passes through the passage opening 52 of the first sealing formation area 34 in the assembled state, a cross-sectional expansion device of the fuel feed line 28, which cross-sectional expansion device is generally designated by 62, is provided at the line area 56. The cross-sectional expansion device may be provided, for example, by a sleeve 64 pushed onto the line area 56 and fixed to it by press fit, i.e., by frictional engagement, or/and by connection in substance, e.g., by welding or soldering. In an alternative embodiment, the sleeve 64 or the cross-sectional expansion area 62 may be provided or fixed by forming in one piece with the line area 56 of the fuel feed line 28. The process of fixing the cross-sectional expansion device 62 preferably takes place before the fuel feed line 28 or the line area 56 is bent into the shape that can be seen in the figures and is connected with its combustion chamber assembly unit connection end area 54 to the combustion chamber assembly unit 18 or to the bottom wall 26 of same, or the attachment 59 providing the external connection end area 58 is fixed, for example, likewise by connection in substance with or/and by pressing onto the line area 56. As an alternative, especially when the cross-sectional expansion device shall be provided by forming in one piece with the line area 56, this process may take place after the line area 56 has been made into the shape intended for installation or/and has been fixed to the bottom area 26 of the combustion chamber assembly unit 18 or to the external connection end area 58.

By providing the cross-sectional expansion device 62 at the line area 56 of the fuel feed line 28, it is ensured that this fuel feed line 28 has a larger cross-sectional dimension in the throughput length area 60 than in the fuel feed line sections of the line area 56 that are located upstream and downstream of throughput length area 60. Provisions may be made, for example, for the fuel feed line 28 to have a cross-sectional dimension, i.e., for example, an external diameter in the throughput length area 60 in case of, for example, an approximately circular circumferential contour, which is in itself in the area of the cross-sectional dimension or of the maximum cross-sectional dimension of the fuel feed line 28 in the area of the external connection area 58 and thus also in the area of the maximum cross-sectional dimension of the fuel feed line 28. Provisions may preferably be made for the cross-sectional dimension in the throughput length area 60 to be at least 90% of the cross-sectional dimension in the external connection area 58 or to be just as large as or larger than the cross-sectional dimension or maximum cross-sectional dimension in the external connection area 58. The first sealing formation area 34 with its passage opening 52 or the cross-sectional dimension, i.e., the internal diameter of the, for example, circular passage opening 52, is then coordinated with the cross-sectional dimension of the throughput length area 60 such that when the throughput length area 60 passes through the passage opening 52, the sealing formation 32 or the sealing element 48 with the material area enclosing the passage opening 52 under prestress is in contact with the outer circumferential surface of the fuel feed line 28 in the area of the throughput length area 60 and thereby produces a tight closure. This means that the passage opening 52 may be dimensioned such that its cross-sectional dimension, i.e., its internal diameter, is larger than the cross-sectional dimension of the line area 56 of the fuel feed line 28 outside the throughput length area 60, so that a tight closure could not be produced without the cross-sectional expansion device 62 in the throughput length area 60. For example, the cross-sectional dimension of the line area 56 in the throughput length area 60 may be at least 105% of the basic opening cross-sectional dimension of the passage opening 52.

Such a dimensioning of the passage opening 52 makes it possible to pass the fuel feed line with its external connection area 58 through the passage opening during the assembly of the vehicle heater 20 without the sealing formation 32 having thereby to be excessively expanded in its first sealing formation area 34. Especially when the cross-sectional dimension of the fuel feed line 28 in the throughput length area 60 is selected such that it is approximately equal to or greater than the cross-sectional dimension or the maximum cross-sectional dimension in the external connection area 58, i.e., the section of the fuel feed line 28 to be positioned outside the circumferential wall 12 of the housing 10, the passage opening 52 can be dimensioned such that its cross-sectional dimension, i.e., for example, internal diameter, is at least 90% of the cross-sectional dimension or maximum cross-sectional dimension of the fuel feed line 28 in the external connection area 58 or is just as large as or is larger than the maximum cross-sectional dimension of the fuel feed line 28 in the external connection area 58. In this manner, an expansion of the sealing formation can be entirely avoided when the fuel feed line 28 is passed through the passage opening 52 up to a phase, in which the throughput line area 60 is inserted into the passage opening 52. Since the passage opening 52 has, in principle, a smaller cross-sectional dimension than the throughput length area 60 of the fuel feed line 28, it is nevertheless guaranteed that the first sealing formation area 34 is in contact with the outer circumferential surface of the throughput length area 60 or of the cross-sectional expansion device 62 due to the inherent elasticity of the sealing formation 32 under prestress in the assembled state and thus produces the tight closure. Hence, this is especially relevant since the fuel-resistant elastomer materials used for the making of the sealing formation 32 can only be expanded elastically within a limited range without damage to the material structure or without a loss of the elastic property leading to or necessary for a tight closure being generated.

In order to avoid damage to the first sealing formation area 34 during the insertion of the fuel feed line 28 into the passage opening 52 when the cross-sectional expansion device 62 is inserted into the passage opening 52, the cross-sectional expansion device 62 preferably has a chamfer at least at its end facing the external connection area 58.

Another advantage of the configuration according to the present invention is that sealing formations with identical configuration can be used for the configuration of different heaters, which use fuel feed lines or line areas having different dimensions, and only an adaptation in the area of the cross-sectional expansion device to different external dimensions of the line area of the fuel feed line is necessary. Thus, sealing formations of identical configuration both for diesel heaters and for gasoline heaters, which generally have fuel feed lines of different cross-sectional dimensions, can be used.

Another advantage is that the configuration or dimensioning of the first sealing formation area 34 according to the present invention makes possible a better compensation of shape tolerances and because of the fact that the cross-sectional expansion device 62 has along the line area 56 an extension length that is markedly greater than the material thickness of the first sealing formation area 34 in the area, in which the passage opening 52 is provided, position inaccuracies, which are generally unavoidable during the assembly of the fuel feed line 28 with the combustion chamber assembly unit 18, have no effect on the interaction of the fuel feed line 28 with the first sealing formation area 34 for providing the tight closure.

With the configuration according to the present invention of a vehicle heater, it can be guaranteed that the escape of fuel or fuel vapors from the combustion air flow space, in which the fuel or fuel vapors may enter during a downtime phase of the vehicle heater, does not occur in the area of the sealing formation 32, and that during the combustion operation, i.e., when the combustion air blower feeds combustion air through the combustion air flow space to the combustion chamber assembly unit, a leak compromising the feeding efficiency does not occur in the area of the sealing formation.

While specific embodiments of the invention have been shown and described in detail to illustrate the application of the principles of the invention, it will be understood that the invention may be embodied otherwise without departing from such principles.

What is claimed is:

1. A vehicle heater comprising:
a housing with a circumferential wall defining a combustion air flow space, the circumferential wall having a fuel feed line passage opening;
a combustion chamber assembly unit to be fed with fuel and combustion air;
a fuel feed line adjoining the combustion chamber assembly unit and configured to feed fuel to the combustion chamber assembly unit, wherein the fuel feed line comprises a combustion chamber assembly unit connection end area, adjoining the combustion chamber assembly unit, an external connection end area, located outside the circumferential wall, and a line area extending between the combustion chamber assembly unit connection end area and the external connection end area and passing through the fuel feed line passage opening; and
a sealing formation comprising a sealing formation area, wherein:
the sealing formation area is positioned meshing with the fuel feed line passage opening providing an essentially fluid-tight closure between the circumferential wall and the line area of the fuel feed line;
the sealing formation has, in the sealing formation area, a sealing formation passage opening through which the line area of the fuel feed line passes;
the fuel feed line has a larger cross-sectional dimension in a throughput length area passing through the sealing formation passage opening in the sealing formation area than in a section of the line area; and
said section of the line area is located between the throughput length area and the external connection area.

2. The vehicle heater in accordance with claim 1, wherein the sealing formation passage opening, without having the throughput length area positioned passing therethrough, has the same cross-sectional dimension as the fuel feed line in the area of the external connection end area.

3. The vehicle heater in accordance with claim 2, wherein the basic opening cross-sectional dimension is at least 90% of the cross-sectional dimension of the fuel feed line in the area of the external connection end area.

4. The vehicle heater in accordance with claim 2, wherein the basic opening cross-sectional dimension is at least 100%, of the cross-sectional dimension of the fuel feed line in the area of the external connection end area.

5. The vehicle heater in accordance with claim 1, wherein a cross-sectional dimension of the fuel feed line in the throughput length area is the same as a cross-sectional dimension of the fuel feed line in the area of the external connection end area.

6. The vehicle heater in accordance with claim 5, wherein the cross-sectional dimension of the fuel feed line in the throughput length area is at least 90% of the cross-sectional dimension of the fuel feed line in the area of the external connection end area.

7. The vehicle heater in accordance with claim 5, wherein the cross-sectional dimension of the fuel feed line in the throughput length area is at least 100% of the cross-sectional dimension of the fuel feed line in the area of the external connection end area.

8. The vehicle heater in accordance with claim 1, wherein a basic opening cross-sectional dimension of the sealing formation passage opening is smaller than a cross-sectional dimension of the fuel feed line in the throughput length area in a state with the fuel feed line not inserted therein, whereby the throughput length area is positioned to pass through the sealing formation passage opening.

9. The vehicle heater in accordance with claim 8, wherein the cross-sectional dimension of the fuel feed line in the throughput length area is at least 105% of the basic opening cross-sectional dimension.

10. The vehicle heater in accordance with claim 8, wherein the cross-sectional dimension of the fuel feed line in the throughput length area is at least 110% of the basic opening cross-sectional dimension.

11. The vehicle heater in accordance with claim 1, further comprising a cross-sectional expansion device wherein the line area of the fuel feed line is enclosed by the cross-sectional expansion device in the throughput length area.

12. The vehicle heater in accordance with claim 1, wherein:
the cross-sectional expansion device is fixed by connection in substance at the line area; or the cross-sectional expansion device is fixed by a frictional engagement at the line area or the cross-sectional expansion device is fixed by connection in substance at the line area and also fixed by a frictional engagement at the line area; or
the cross-sectional expansion device forms one piece with the line area.

13. The vehicle heater in accordance with claim 1, further comprising a combustion air blower adjoining an end face of the circumferential wall of the housing in a direction of a housing longitudinal axis, the combustion air blower being configured to feed combustion air into the combustion air flow space, wherein:
the sealing formation area is a first sealing formation area;
the sealing formation has a second sealing formation area; and
the second sealing formation area is arranged between the end face of the circumferential wall and the blower housing and forms an essentially fluid-tight closure between the end face of the circumferential wall and a blower housing of the combustion air blower.

14. The vehicle heater in accordance with claim 13, wherein:
the sealing formation comprises a sealing element providing the first sealing formation area and the second sealing formation area; or/and
the second sealing formation area has a ring-shape configuration adapted to a circumferential contour of the circumferential wall; or
the sealing formation comprises a sealing element providing the first sealing formation area and the second sealing formation area and the second sealing formation area has a ring-shape configuration adapted to a circumferential contour of the circumferential wall.

15. The vehicle heater in accordance with claim 13, wherein the first sealing formation area extends from the second sealing formation area so as to project essentially in a direction of the housing longitudinal axis and to mesh with the fuel feed line passage opening.

16. The vehicle heater in accordance with claim 1, wherein the sealing formation is made of elastomer material.

17. The vehicle heater in accordance with claim 1, wherein:
the housing is part of a heat exchanger housing; and
the combustion chamber assembly unit is carried at a bottom area of the heat exchanger housing.
